(19) United States
(12) Patent Application Publication
(10) Pub. No.: US 2024/0085244 A1
(43) Pub. Date: Mar. 14, 2024

(54) SEAL STRIP TEMPERATURE MONITORING SYSTEMS AND ASSEMBLIES THEREFOR

(71) Applicant: Stowe Woodward Licensco LLC, Youngsville, NC (US)

(72) Inventors: Wesley C. Van Pelt, Appleton, WI (US); Christopher Mason, Bunker Hill, WV (US)

(21) Appl. No.: 18/452,784

(22) Filed: Aug. 21, 2023

Related U.S. Application Data
(60) Provisional application No. 63/375,587, filed on Sep. 14, 2022.

(51) Int. Cl. G01K 1/14; D21F 5/02; D21F 5/04; D21G 9/00

(52) U.S. Cl. CPC G01K 1/14; D21F 5/022; D21F 5/042; D21G 9/0036; D21G 9/0054

(57) ABSTRACT

An assembly includes: a seal strip with an upper wear surface and an opposed lower surface, the seal strip configured to provide a seal for a suction roll, the seal strip comprising a first material having a first thermal conductivity; a seal strip holder, the seal strip residing in the seal strip holder and movable relative thereto; and a temperature monitoring system. The temperature monitoring system comprises: a heat-conducting rod at least partially embedded in the seal strip, the heat-conducting rod comprising a second material, wherein the second material has a second thermal conductivity that is higher than the first thermal conductivity; a temperature sensor connected with the heat-conducting rod for sensing temperature in the heat-conducting rod, and a controller operatively connected with the temperature sensor, the controller configured to receive signals from the temperature sensor and process the signals to indicate a temperature of the upper surface of the seal strip.

### RELATED APPLICATION

The present application claims priority from and the benefit of U.S. Provisional Patent Application No. 63/375,587, filed Sep. 14, 2022, the disclosure of which is hereby incorporated herein by reference in full.

### FIELD OF THE INVENTION

The present invention is directed generally to papermaking, and more specifically to suction rolls and equipment within a papermaking machine.

### BACKGROUND OF THE INVENTION

Paper manufacturing inherently requires at many points in the production process the removal of water. In general the paper pulp (slurry of water and wood and other fibers) rides on top of a felt (in the form of a wide belt) which acts as a carrier for the wet pulp before the actual sheet of paper is formed. Felts are used to carry the pulp in the wet section of the paper machine until enough moisture has been removed from the pulp to allow the paper sheet to be processed without the added support added by the felt.

Quite commonly on the wet end of a paper machine the first water removal is accomplished using a suction roll in a press section (be it a couch, pickup, or press suction roll) used in conjunction with a standard press roll without holes (or against a Yankee dryer in a tissue machine) that mates in alignment with the suction roll. The felt pulp carrier is pressed between these two rolls.

The main component of a suction roll 10 includes a hollow shell 12 (FIG. 1) made of stainless steel, bronze or other metal that has tens of thousands of holes, drilled in a prescribed pattern radially around the circumference of the roll. These holes are gauged in size (ranging from under ⅛″ to nearly ¼″) and are engineered for the particular paper material to be processed. It is these holes that form the “venting” for water removal. This venting can typically range from approximately 20 to 45 percent of the active roll surface area. The suction roll shell is driven by a drive system that rotates the shell around a stationary core called a suction box.

The suction box 20 (FIG. 2) can be thought of as conventional long rectangular box without a lid on the top and with ports on the end, bottom or sides. The end (specifically the drive end) of the box typically has a pilot bearing of which the inner raceway is a pilot bushing or bearing with a slip fit to a journal on the suction box and the outer raceway is pressed onto the rotating shell. The suction box 20 is connected with a suction source (e.g., a vacuum pump). An exemplary suction box and shell are shown in U.S. Pat. No. 6,358,370 to Huttunen, the disclosure of which is hereby incorporated herein in its entirety.

In order to take advantage of the holes in the shell, a vacuum zone 30 must be created using these ports on the inside of the suction roll shell in a zone that is directly underneath the paper pulp that is being processed. This is accomplished by the suction box 20 using a slotted holder 32 which holds a seal along the long axis of the suction box on both sides. FIG. 2 shows the slotted holders 32, and FIGS. 3 and 4 show two varieties of seals 34, 34′ which are in the form of strips (hereinafter “seal strips”). In addition to these long seals there are two shorter seals (called end deckles) on the short ends (called tending and drive ends) that have some axial adjustment as needed to accommodate various sheet widths.

The seal strips 34, 34′ are usually made of rubberized polymerized graphite and are held nearly in contact with the inner surface of the shell 12 during operation (see FIGS. 3 and 4). Between the seal strips 34, 34′ a constant vacuum is drawn. This allows the vacuum zone 30 to be created underneath the sheet 40 as is passes over the roll 10. The seal strips 34, 34′ are biased upwardly toward the suction roll shell 12 by load tubes 142, which are sealed hoses that run underneath the entire length of the seal strip 34, 34′. Pressure in the load tube 142 expands the load tube 142 (much like air in a balloon) and lifts the seal strip 34, 34′ toward the inside surface of the shell 12. This effect, along with help from the system vacuum from the suction box 20 and the laminar flow of lubrication water mentioned previously, forms the seal between the edge of the seal strip 34 and the inside of the shell 12.

In actual application, in a properly functioning suction roll the seal strips 34, 34′ never directly contact the inside of the suction roll shell 12. If the seal strips 34, 34′ do contact the shell 12 they would wear away and would quickly lose their sealing ability. In order to eliminate or significantly reduce this wear and to provide a seal, water is applied along the length of the seal strips 34, 34′ with a lubrication shower formed with water flowing through a spray nozzle 24 (see FIG. 2). This shower keeps the seal strips 34, 34′ lubricated with a laminar flow of water between the seal surface and the inside surface of the shell 12.

The amount of water used for lubrication should be gauged properly so that the proper amount of lubrication is applied to keep the seal strips 34, 34′ lubricated, but not so much to either become an issue for the pulp being processed or to be wasting water. In addition, process water used in a paper mill may contain chemicals and also significant particulates that may clog the lubrication shower nozzles 24 during normal operation. Since these nozzles 24 are located inside the rotating shell 12 they are not visible to the paper machine operator.

Seal strips are typically replaced periodically after some degree of wear occurs. However, because the seal strips inside a suction roll are not visible to the operator of the paper making equipment or to anyone trying to view the seal strips, many conditions inside an operating suction roll, including seal strip temperature, are unknown. Some conditions, such as an increase in temperature of the surface of the seal strip, can indicate improper operation or poor efficiency. As such, a reliable method of detecting the seal strip temperature to inform the operator of the paper making equipment that maintenance is needed on the equipment before a failure occurs may be desirable.

### SUMMARY

As a first aspect, embodiments of the invention are directed to an assembly comprising: a seal strip with an upper wear surface and an opposed lower surface, the seal strip configured to provide a seal for a suction roll, the seal strip comprising a first material having a first thermal conductivity; a seal strip holder, the seal strip residing in the seal strip holder and movable relative thereto; and a temperature monitoring system. The temperature monitoring system comprises: a heat-conducting rod at least partially embedded in the seal strip, the heat-conducting rod comprising a second material, wherein the second material has a second thermal conductivity that is higher than the first thermal conductivity; a temperature sensor connected with the heat-conducting rod for sensing temperature in the heat-conducting rod, and a controller operatively connected with the temperature sensor, the controller configured to receive signals from the temperature sensor and process the signals to indicate a temperature of the upper surface of the seal strip.

As a second aspect, embodiments of the invention are directed to an assembly comprising: a seal strip with an upper wear surface and an opposed lower surface, the seal strip configured to provide a seal for a suction roll, the seal strip comprising a first material having a first thermal conductivity; a seal strip holder, the seal strip residing in the seal strip holder and movable relative thereto; and a temperature monitoring system. The temperature system comprises: a heat-conducting rod at least partially embedded in the seal strip, the heat-conducting rod comprising a second material, wherein the second material has a second thermal conductivity that is at least 50 to 1,000 times higher than the first thermal conductivity; a temperature sensor connected with the heat-conducting rod for sensing temperature in the heat-conducting rod; and a controller operatively connected with the temperature sensor, the controller configured to receive signals from the temperature sensor and process the signals to indicate a temperature of the upper surface of the seal strip.

As a third aspect, embodiments of the invention are directed to an assembly comprising: a seal strip with an upper wear surface and an opposed lower surface, the seal strip configured to provide a seal for a suction roll, the seal strip comprising a first material having a first thermal conductivity; a seal strip holder, the seal strip residing in the seal strip holder and movable relative thereto; and a temperature monitoring system. The temperature system comprises: a heat-conducting rod at least partially embedded in the seal strip and extending between the upper wear surface and the lower surface of the seal strip, the heat-conducting rod comprising a second material, wherein the second material has a second thermal conductivity that is higher than the first thermal conductivity; a temperature sensor connected with the heat-conducting rod for sensing temperature in the heat-conducting rod, and a controller operatively connected with the temperature sensor, the controller configured to receive signals from the temperature sensor and process the signals to indicate a temperature of the upper surface of the seal strip.

### BRIEF DESCRIPTION OF THE FIGURES

FIG. 1 is a perspective end view of a typical paper machine suction roll.

FIG. 2 is an enlarged perspective end view of the suction box area of a typical suction roll.

FIG. 3 is an end view of the suction box area and seal strips of a conventional suction roll.

FIG. 4 is an end view of the suction box area and seal strips of another conventional suction roll.

FIG. 5 is a schematic end view of a seal strip and temperature monitoring system according to embodiments of the invention.

FIG. 6 is an enlarged fragmentary perspective view of the seal strip and temperature monitoring system of FIG. 5.

FIG. 7 is a schematic diagram illustrating the electronic components of the temperature monitoring system of FIG. 5.

FIG. 8 is a schematic diagram illustrating an alternative arrangement of the electronic components of the temperature monitoring system of FIG. 5.

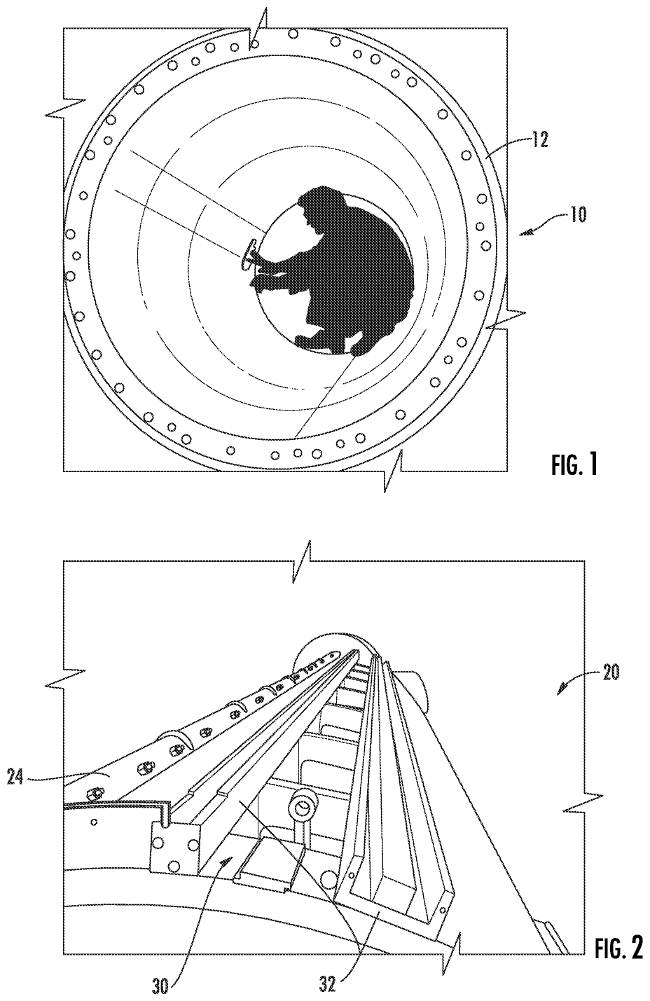

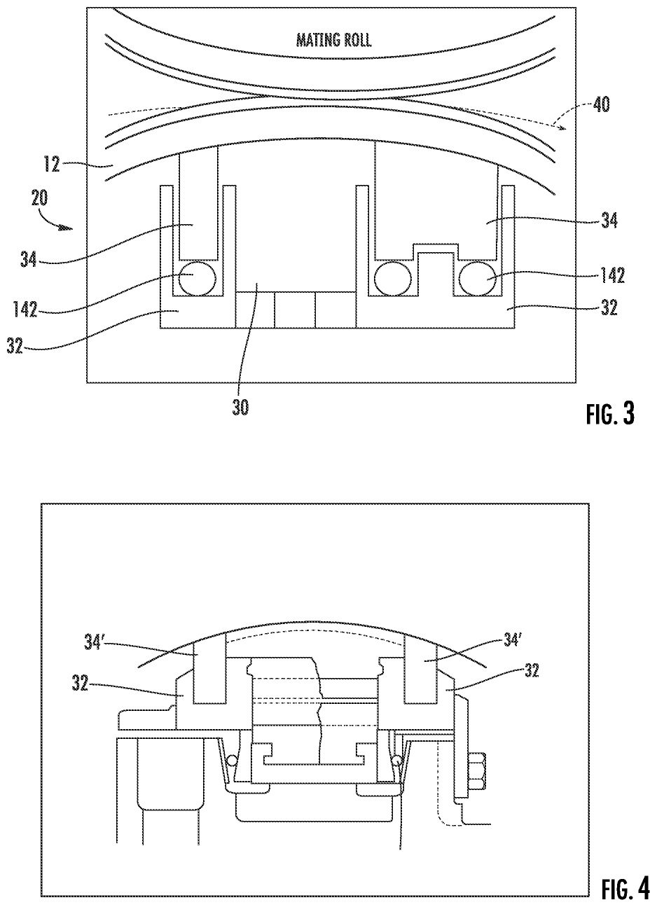

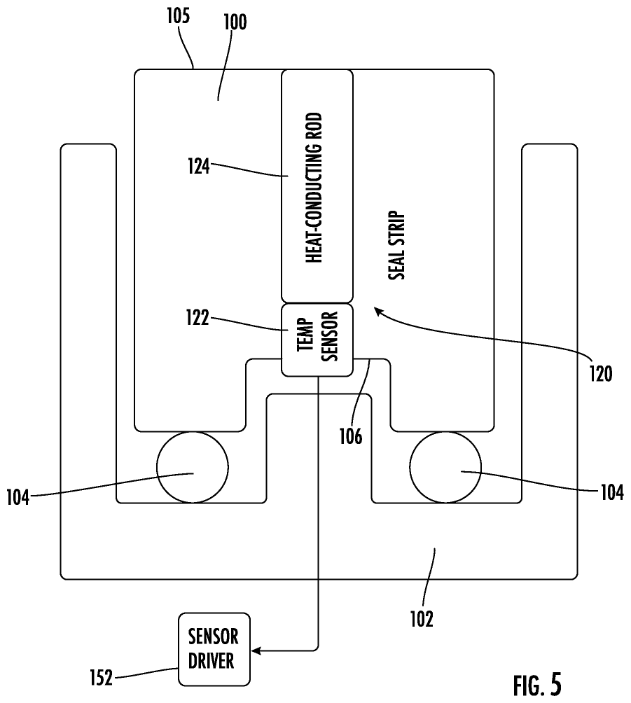

### DETAILED DESCRIPTION

The present invention will now be described more fully hereinafter, in which embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, like numbers refer to like elements throughout. Thicknesses and dimensions of some components may be exaggerated for clarity.

In addition, spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

Well-known functions or constructions may not be described in detail for brevity and/or clarity.

Referring now to the drawings, a seal strip 100 and an accompanying temperature monitoring system 120 are shown in FIGS. 5-8. With the exception of accommodations for the temperature monitoring system 120 described below, the seal strip 100 is of conventional design: it is elongate and of generally constant cross-section (shown as rectangular in FIG. 5); it resides within a channel-shaped holder 102 and is supported by load tubes 104 against its lower surface 106; the load cells 104 contact the lower surface 106 and bias the seal strip 100 upwardly (i.e., toward the shell of a suction roll) so that its upper surface 105 (i.e., its wear surface) confronts the shell and contributes to a seal therewith; and it is formed of a polymeric material such as rubber (which may be filled with a filler, such as graphite).

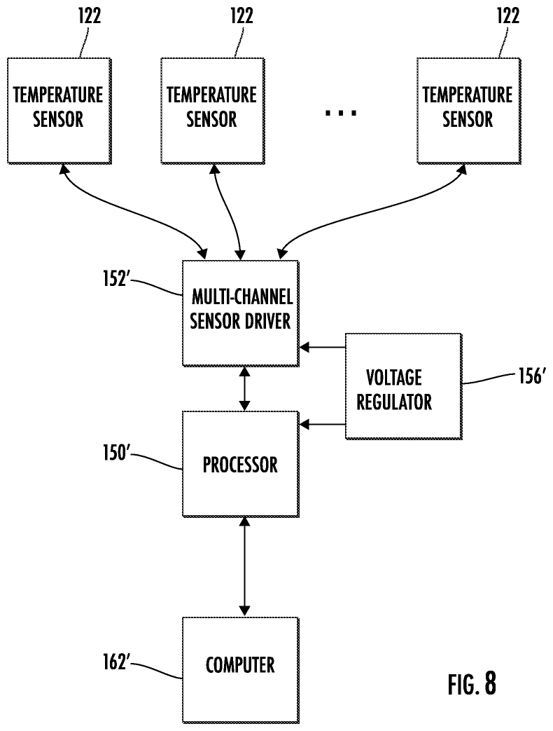

The temperature monitoring system 120 includes one or more temperature sensors 122 that are located near or below the lower surface of the seal strip 100. The temperature sensors 122 may be of conventional construction; exemplary temperature sensors include thermocouples, thermistors and thermopiles. The temperature sensors 122 are operatively connected with a processor 150 (see also FIGS. 7 and 8) that receives signals from the temperature sensors 122 and converts these signals into monitoring data.

Although only a single temperature sensor 122 is illustrated herein, in some embodiments the temperature monitoring system 120 includes temperature sensors 122 at different positions along the length of the seal strip 100. For example, five temperature sensors 122 may be deployed in a seal strip 100: one at or adjacent each end of the seal strip 100; one in the middle of the seal strip 100; and one at each “quarter” location along the length of the seal strip 100. Such dispersion can provide temperature data from different locations along the upper surface of the seal strip 100, which can help a technician to discern a specific problem area.

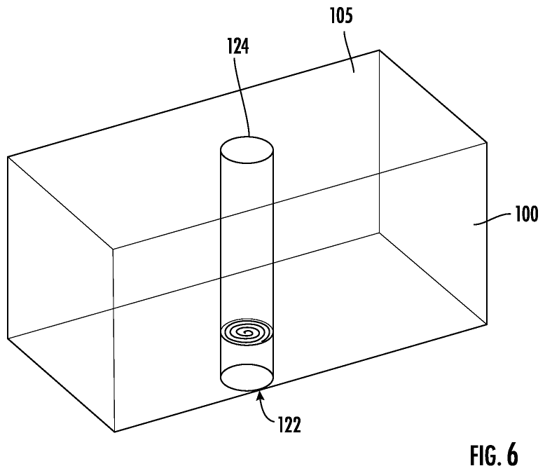

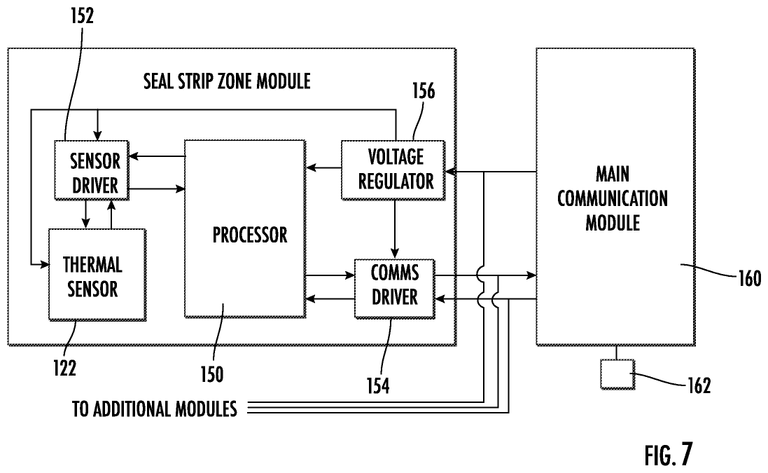

As shown in FIGS. 5 and 6, the temperature monitoring system 120 also includes one or more heat-conducting rods 124, each of which is associated with a respective temperature sensor 122. As shown in FIGS. 5 and 6, the heat-conducting rods 124 comprise a material that conducts heat more readily than the material employed in the seal strip 100. As a result, the heat-conducting rods 124 convey heat more rapidly than the remaining material of the seal strip 100, thereby enabling the temperature sensors 122 to more quickly and precisely detect temperature changes at the surface of the seal strip 100.

As shown in FIGS. 5 and 6, in some embodiments the heat-conducting rods 124 extend through the entire height of the seal strip 100; i.e., the heat-conducting rods 124 are exposed on both the upper (wear) surface 105 and the lower surface 106 of the seal strip 100. Exposure at the upper surface 105 of the seal strip 100 may enable the heat-conducting rod 124 to provide particularly accurate temperature data from the upper surface. Exposure at the lower surface 106 of the seal strip 100 may enable simple connection with the temperature sensor 122 as it mounted outside of the seal strip 100, which in turn may enable the temperature sensor 122 to more easily be connected (either hard-wired or wirelessly) with the processor 150 (see FIGS. 7 and 8). However, in other embodiments the heat-conducting rods 124 may not extend to either or both of the wear surface 105 and the lower surface 106.

In selecting materials for the seal strip 100 and the heat-conducting rods 124, there may be restrictions. On the one hand, the distance between the wear surface 105 of the seal strip 100 and the temperature sensor 122 can impact the choice of materials; the greater the distance the heat is required to be conducted between the wear surface 105 and the temperature sensor 122, the more desirable a material with a higher thermal conductivity may be. On the other hand, some similarity between the materials of the seal strip 100 and the heat-conducting rod 124 may be desirable, as (a) materials having somewhat similar hardness can prevent wear or damage to the surface of the roll mating with the seal strip 100, and (b) if the materials of the heat-conducting rods 124 creates a significantly higher degree of friction than the material of the seal strip 100, heat generated by such friction may cause inaccurate temperature readings. In some embodiments, the heat-conducting rod 124 may be formed of a material having a thermal conductivity that is between about 50 and 1,000 times greater than that of the material of the seal strip 100.

As one example, if the seal strip 100 is formed of rubber impregnated with graphite (which is a typical seal strip construction), the heat-conducting rod 124 may be formed of graphene. Graphene has a thermal conductivity of ^{˜}4000 Wm⁻¹K⁻¹, whereas graphite-filled rubber may have a thermal conductivity of about 10 to 20 Wm⁻¹K⁻¹. As a result, heat is conducted within graphene much more easily than in graphite-filled rubber.

In some embodiments, and as shown in FIG. 6, the heat-conducting rods 124 are formed of tightly coiled graphene sheets. In such embodiments, epoxy or another adhesive/potting compound may be employed to fill any gaps between the layers of the coiled graphene sheets and/or to provide a seal that can prevent moisture from the papermaking process from seeping into the space occupied by the heat-conducting rod 124.

In some embodiments, the graphene sheets are between about 300 pm and 200 μm in thickness (about 25 μm is typical), and/or the heat-conducting rod 124 formed by the graphene sheets is about ⅛ and ½ inches in diameter.

Other exemplary materials for the heat-conducting rods 124 include carbon nanotubes, metals such as copper, silver and aluminum, and polymeric materials filled with such materials.

In operation of the papermaking machine, rotation of the suction roll 10 relative to the seal strip 100 generates heat. That heat spreads downwardly toward the base of the seal strip 100, decreasing in intensity as the distance increases. The heat is conveyed throughout the seal strip 100, including to and through the heat-conducting rods 124 to the temperature sensors 122. From this information, an array of temperatures is determined for the seal strip 100 at different points along the surface of the seal strip 100, which can be used to assess potential wear of the surface of the seal strip 100.

Exemplary electronic components of the temperature monitoring system 120 are shown in FIG. 7. These may include a processor 150 and driver circuitry 152, which are used to interface with the sensors 122. A communications driver 154 acts as a bridge between the processor 150 and a main communication module 160, which is mounted remotely from the seal strip 100. A voltage regulation section 156 allows for the appropriate voltages to be supplied to the system. The main communication module 160 allows for wireless communication between the system and an operator display 162).

An alternative configuration is shown in FIG. 8. In this configuration, the temperature sensors 122 are connected to the display 162′ via a single processor 150′. The processor 150 is then connected with the remote operator display 162′, and is also connected to a voltage regulator 156′. This arrangement processes analog signals directly, thereby eliminating the need for some of the modules shown in FIG. 7.

Regarding the electronics and microcontrollers discussed above, embodiments of the present inventive concepts may be embodied in hardware and/or in software (including firmware, resident software, micro-code, etc.). Furthermore, exemplary embodiments of the present inventive concepts may take the form of a computer program product comprising a non-transitory computer-usable or computer-readable storage medium having computer-usable or computer-readable program code embodied in the medium for use by or in connection with an instruction execution system. In the context of this document, a computer-usable or computer-readable medium may be any medium that can contain, store, communicate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, or device. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Exemplary embodiments of the present inventive concepts are described herein with reference to flowchart and/or block diagram illustrations. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means and/or circuits for implementing the functions specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

In some embodiments the controller may be connected to or associated with (either hard-wired or wirelessly) a display device (e.g., a monitor, tablet, smart phone, laptop, etc.) that can produce one or more visual displays regarding the temperature, wear and/or lubrication parameters of the system. Also, in some embodiments, the controller is configured to make recommendations regarding the amount of lubrication based on the “wear” signals and/or the temperature signals from the temperature sensors within the seal strips. The controller may also be configured to provide an alert or alarm (visual, auditory, or otherwise) to signal that a certain threshold parameter has been reached (e.g., a threshold temperature or wear level) so that the parameter of interest can be addressed.

It should also be noted that the temperature monitoring system 120 may employ different components for performing different functions. For example, the load tubes 104 may be replaced with other components (e.g., springs, resilient pads, or the like) that bias the seal strips 100 toward the shell of the suction roll. The seal strip holder 102 may take different configurations. Other variations may also be employed.

Also, in some embodiments the seal strip 100 may also include a wear monitoring system that measures the degree of wear experienced by the seal strip. Exemplary wear monitoring systems are described in, for example, U.S. Patent Publication Nos. 2018/0313035 to Reaves et al; 2017/0254019 to Keinberger et al; and 2022/0145538 to Kilbourne et al, the disclosures of which are hereby incorporated by reference herein in full.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as recited in the claims. The invention is defined by the following claims, with equivalents of the claims to be included therein.

What is claimed is:

1. An assembly, comprising:
a seal strip with an upper wear surface and an opposed lower surface, the seal strip configured to provide a seal for a suction roll, the seal strip comprising a first material having a first thermal conductivity;
a seal strip holder, the seal strip residing in the seal strip holder and movable relative thereto; and
a temperature monitoring system comprising:
a heat-conducting rod at least partially embedded in the seal strip, the heat-conducting rod comprising a second material, wherein the second material has a second thermal conductivity that is higher than the first thermal conductivity;
a temperature sensor connected with the heat-conducting rod for sensing temperature in the heat-conducting rod, and
a controller operatively connected with the temperature sensor, the controller configured to receive signals from the temperature sensor and process the signals to indicate a temperature of the upper surface of the seal strip.

2. The assembly defined in claim 1, wherein the heat-conducting rod extends to the wear surface of the seal strip.

3. The assembly defined in claim 1, wherein the heat-conducting rod extends to the lower surface of the seal strip.

4. The assembly defined in claim 1, wherein the heat-conducting rod comprises graphene.

5. The assembly defined in claim 4, wherein the heat-conducting rod comprises a coiled graphene sheet.

6. The assembly defined in claim 1, wherein the seal strip comprises graphite-impregnated rubber.

7. A suction roll, comprising:
a cylindrical shell having an internal lumen and a plurality of through holes;
a suction box positioned in the lumen of the shell; and
a suction source operatively connected with the suction box; and
an assembly of claim 1, wherein the seal strip and seal strip holder are mounted in the suction box, such that the upper surface of the seal strip confronts an inner surface of the shell.

8. An assembly, comprising:
a seal strip with an upper wear surface and an opposed lower surface, the seal strip configured to provide a seal for a suction roll, the seal strip comprising a first material having a first thermal conductivity;
a seal strip holder, the seal strip residing in the seal strip holder and movable relative thereto; and
a temperature monitoring system comprising:
a heat-conducting rod at least partially embedded in the seal strip, the heat-conducting rod comprising a second material, wherein the second material has a second thermal conductivity that is at least 50 to 1,000 times higher than the first thermal conductivity;
a temperature sensor connected with the heat-conducting rod for sensing temperature in the heat-conducting rod, and
a controller operatively connected with the temperature sensor, the controller configured to receive signals from the temperature sensor and process the signals to indicate a temperature of the upper surface of the seal strip.

9. The assembly defined in claim 8, wherein the heat-conducting rod extends to the wear surface of the seal strip.

10. The assembly defined in claim 8, wherein the heat-conducting rod extends to the lower surface of the seal strip.

11. The assembly defined in claim 8, wherein the heat-conducting rod comprises graphene.

12. The assembly defined in claim 11, wherein the heat-conducting rod comprises a coiled graphene sheet.

13. The assembly defined in claim 8, wherein the seal strip comprises graphite-impregnated rubber.

14. A suction roll, comprising:
a cylindrical shell having an internal lumen and a plurality of through holes;
a suction box positioned in the lumen of the shell; and
a suction source operatively connected with the suction box; and
an assembly of claim 8, wherein the seal strip and seal strip holder are mounted in the suction box, such that the upper surface of the seal strip confronts an inner surface of the shell.

15. An assembly, comprising:
a seal strip with an upper wear surface and an opposed lower surface, the seal strip configured to provide a seal for a suction roll, the seal strip comprising a first material having a first thermal conductivity;
a seal strip holder, the seal strip residing in the seal strip holder and movable relative thereto; and
a temperature monitoring system comprising:
a heat-conducting rod at least partially embedded in the seal strip and extending between the upper wear surface and the lower surface of the seal strip, the heat-conducting rod comprising a second material, wherein the second material has a second thermal conductivity that is higher than the first thermal conductivity;
a temperature sensor connected with the heat-conducting rod for sensing temperature in the heat-conducting rod, and
a controller operatively connected with the temperature sensor, the controller configured to receive signals from the temperature sensor and process the signals to indicate a temperature of the upper surface of the seal strip.

16. The assembly defined in claim 15, wherein the heat-conducting rod comprises graphene.

17. The assembly defined in claim 16, wherein the heat-conducting rod comprises a coiled graphene sheet.

18. The assembly defined in claim 15, wherein the seal strip comprises graphite-impregnated rubber.

19. A suction roll, comprising:
a cylindrical shell having an internal lumen and a plurality of through holes;
a suction box positioned in the lumen of the shell; and
a suction source operatively connected with the suction box; and
an assembly of claim 15, wherein the seal strip and seal strip holder are mounted in the suction box, such that the upper surface of the seal strip confronts an inner surface of the shell.
